(19) United States
(12) Patent Application Publication
(10) Pub. No.: US 2003/0213765 A1
(43) Pub. Date: Nov. 20, 2003

(54) Tower crane with raising platform

(76) Inventor: Andre St-Germain, St-Bonaventure (CA)

Correspondence Address: Andre St-Germain, c/o PROTECTIONS EQUINOX INT'L INC., Suite 224, 4480, Cote-de-Liesse, Montreal, QC, H4N 2R1, CA

(21) Appl. No.: 10/440,227

(22) Filed: May 19, 2003

Related U.S. Application Data
(60) Provisional application No. 60/381,370, filed on May 20, 2002.

(51) Int. Cl. B66C 23/26

(52) U.S. Cl. 212/294

(57) ABSTRACT

A self-erecting tower crane for use on a construction site is supported at a top end of a tower that includes tower sections assembled in an end-to-end relationship relative to one another along a tower axis. The tower crane includes a boom assembly for selectively raising tower sections above ground. A boom support structure has an upper portion that rotatably supports the boom assembly relative to the tower axis, and a lower portion that is configured and sized for mounting on and releasably securing to the tower top end. A self-raising sleeve mounts on the tower for axial movement therealong, and selectively and releasably supports the boom support structure on the tower. The sleeve and the boom support structure include a side opening that is configured and sized for allowing a tower section to be assembled to the tower top end for the self-erection of the tower crane.

### CROSS-REFERENCE TO RELATED APPLICATION

This application is related to U.S. Provisional Application for Patent Serial No. 60/381,370 filed on May 20, 2002.

### FIELD OF THE INVENTION

The present invention relates to tower cranes, and more particularly to a self-erecting tower crane with a raising platform.

### BACKGROUND OF THE INVENTION

Tower cranes are well known in the construction art. Depending on their size, tower cranes are used in the construction of medium to high-rise buildings and the like structures. These buildings fabricated one floor at a time using concrete need the proximity of a tower crane for the transfer of all the forming structure material, and other, from one completed floor level to the next above. This transfer of material between floors as well as the raising of other material and/or people of different building trades to different floors takes a lot of time, and often, the crane is standing waiting for someone to be ready, all of this making the rental cost of the tower crane relatively expensive.

Accordingly, it would be too costly to proceed the same way with the construction of small to medium size buildings, unless they are high-tech buildings or expensive condominiums, lofts or the like. Consequently, the structure of small to medium size buildings is usually made out of either steel or wooden beams with the floors and walls made out of wood material.

Everyone knows that wood material is not the best material for fire protection as well as for noise isolation between floors and adjacent rooms.

Accordingly, there is a need to made the concrete-type construction affordable for small to medium size buildings.

Furthermore, the tower cranes used on construction sites have as their only purpose the duty to raise or lower various materials. None of them can be simultaneously used for other purposes.

On the other hand, today's hydraulic-type scaffoldings are also well known but are neither capable nor designed for carrying large and/or heavy pieces of material. In order to use such scaffoldings, some large concrete forming structures would need to be disassembled prior to be mounted on the scaffolding and then reassembled at the next higher level before use; which is really time consuming and therefore costly.

Consequently, there is a need for an improved tower crane, especially for use in the construction of concrete based small to medium size buildings, while making the cost of such construction much more affordable than what is obtained using conventional tower cranes and scaffoldings.

### SUMMARY OF THE INVENTION

It is therefore a general object of the present invention to provide an improved tower crane with raising platform.

An advantage of the present invention is that the tower crane with raising platform obviates the above noted disadvantages.

Another advantage of the present invention is that the tower crane with raising platform is a self-erecting (and self-disassembling) crane.

A further advantage of the present invention is that the tower crane with raising platform can, depending of the constructor needs, be used either as a stand alone crane or as a crane having an independent scaffolding platform (or elevator) releasable therefrom for being displaced along the tower.

Yet another advantage of the present invention is that the tower crane with raising platform is modular and can be easily loaded and unloaded from conventional trucks/trailers using a conventional forklift or the like.

Another advantage of the present invention is that the tower of the tower crane with raising platform can be anchored to the building being constructed in order to improve the overall structural rigidity of the tower crane, without affecting displacement of the raising platform or the like along the tower.

Another advantage of the present invention is that the tower crane with raising platform can be at least partially remotely operated from ground, especially during the self-erecting process.

Still another advantage of the present invention is that the raising platform of the tower crane with raising platform can support a large platform while the crane is operating at the top end thereof.

Yet a further advantage of the present invention is that the tower of the tower crane can remain on the construction site for the raising platform to move there along after the tower crane has been removed from the top end thereof.

According to an aspect of the present invention, there is provided a self-erecting tower crane for use on a construction site, the tower crane being supported at a top end of a tower, the tower including tower sections assembled in an end-to-end relationship relative to one another along a tower axis, the tower crane comprises: a boom assembly for selectively raising tower sections above ground; a boom support structure defining generally opposed structure upper and lower portions, the structure upper portion rotatably supporting the boom assembly relative to the tower axis, the structure lower portion being configured and sized for mounting on and releasably securing to the tower top end; and a self-raising sleeve mounted on the tower for axial movement therealong, the self-raising sleeve selectively and releasably supporting the boom support structure on the tower, the self-raising sleeve and the boom support structure being configured and sized for allowing a tower section to be assembled to the tower top end so as to allow self-erection of the tower crane.

In one embodiment, the self-raising sleeve includes a sleeve sidewall for outwardly surrounding the tower, the sleeve sidewall defining generally opposed sleeve first and second longitudinal ends, the sleeve sidewall including a sleeve side opening extending therethrough inwardly from the sleeve first end, the sleeve side opening being configured and sized for allowing at least a portion of a tower section to pass generally transversely therethrough so as to assemble the tower section onto the tower top end and extend the tower. Typically, the sleeve side opening is configured and sized for allowing a full tower section to pass generally transversely therethrough.

In one embodiment, the self-raising sleeve includes a sleeve closing body releasably mountable thereon to at least partially close the sleeve side opening.

Typically, the sleeve closing body is pivotally mounted on the sleeve sidewall, the sleeve closing body pivoting between first and second limit positions, the sleeve closing body allowing insertion of at least a portion of a tower section through the sleeve opening when in the first position and at least partially closing the sleeve opening so as to better secure the self-raising sleeve to the tower when in the second limit position.

In one embodiment, the structure lower portion includes a structure sidewall for outwardly surrounding the tower, the structure sidewall defining a structure first longitudinal end thereof located away from the structure upper portion, the structure sidewall including a structure side opening extending therethrough inwardly from the structure first end, the structure side opening being configured and sized for allowing at least an upper portion of a tower section to pass generally transversely therethrough so as to assemble the tower section onto the tower top end.

In one embodiment, the structure side opening is configured and sized for allowing a full tower section to pass generally transversely therethrough.

In one embodiment, the structure lower portion includes a structure sidewall for outwardly surrounding the tower, the structure sidewall including a structure side opening extending therethrough, the structure sidewall defining a structure first longitudinal end thereof located away from the structure upper portion, the structure side opening being configured, sized and positionable in face-to-face relationship relative to the sleeve side opening so as to form a common opening that allows a full tower section to pass generally transversely therethrough so as to assemble the tower section onto the tower top end.

In one embodiment, the structure upper portion includes a boom interface releasably mounted thereon, the boom interface rotatably supporting the boom assembly relative to the tower axis.

Typically, the boom support structure includes a crane power system operatively connected to the crane for operation thereof.

Typically, the boom support structure includes a user platform secured thereto for allowing a user to selectively and closely operate the tower crane.

Typically, the crane power system includes a remote controller connected thereto so as to allow a user to remotely operate the tower crane.

In one embodiment, the self-raising sleeve includes a sleeve power system operatively connected thereto for axial displacement of the self-raising sleeve relative to the tower. Typically, the self-raising sleeve includes a platform releasably mounted thereon so as to selectively support material to be carried along the tower.

Typically, the tower includes a tower anchor to secure the tower to an adjacent building structure, the self-raising sleeve including a sleeve sidewall outwardly surrounding the tower, the sleeve sidewall having a longitudinal slit extending therethrough for allowing the self-raising sleeve to clear the tower anchor when being displaced along the tower.

Typically, the tower includes spaced-apart generally horizontal rungs, the sleeve power system including a hydraulic ram mounted on the self-raising sleeve, the hydraulic ram including a hook member for releasable engagement with the tower rungs.

In one embodiment, the structure lower portion includes a structure sidewall for outwardly surrounding the tower, the structure lower portion includes a hoist beam extending generally outwardly therefrom and through the structure sidewall, the hoist beam including a cable hoist assembly for releasably supporting a tower section, the cable hoist assembly being displaceable along the hoist beam between a first position outside the structure sidewall and a second position inside the structure sidewall.

Typically, the structure sidewall defines a structure first longitudinal end thereof located away from the structure upper portion, the structure sidewall including a structure channel opening extending therethrough inwardly from the structure first end, the hoist beam extending through the structure channel opening for allowing at least a portion of the cable hoist assembly to be displaced between the first and second positions outside and inside.

Other objects and advantages of the present invention will become apparent from a careful reading of the detailed description provided herein, with appropriate reference to the accompanying drawings.

### BRIEF DESCRIPTION OF THE DRAWINGS

Further aspects and advantages of the present invention will become better understood with reference to the description in association with the following Figures, in which like reference characters indicate like elements throughout, wherein:

FIG. 1 is an exploded top perspective view of an embodiment of a tower crane with a raising platform in accordance with the present invention, showing how the different components are attached to each other;

FIG. 2 is a perspective view of the embodiment of FIG. 1, showing how the tower crane is self-erecting by lifting a next higher tower section for attachment on the tower;

FIG. 3 is a partially broken section view taken along line 3-3 of FIG. 1, showing the lateral access opening for allowing a tower section to be mounted on top of the tower;

FIG. 4 is a partially broken enlarged exploded perspective view of the embodiment of FIG. 1, showing the attachment of the tower crane to the top end of the tower;

FIG. 5 is a top perspective view of the embodiment of FIG. 1, showing the raising platform and the tower crane being used independently of each other, along the tower and at the top end of the tower respectively;

FIG. 6 is a side view of FIG. 5, showing the tower being releasably secured to the building structure; and

FIG. 7 is a view similar to FIG. 6, showing another embodiment of a rotating tower crane with a raising platform in accordance with the present invention.

### DETAILED DESCRIPTION OF THE PREFERRED EMBODIMENTS

With reference to the annexed drawings the preferred embodiments of the present invention will be herein described for indicative purpose and by no means as of limitation.

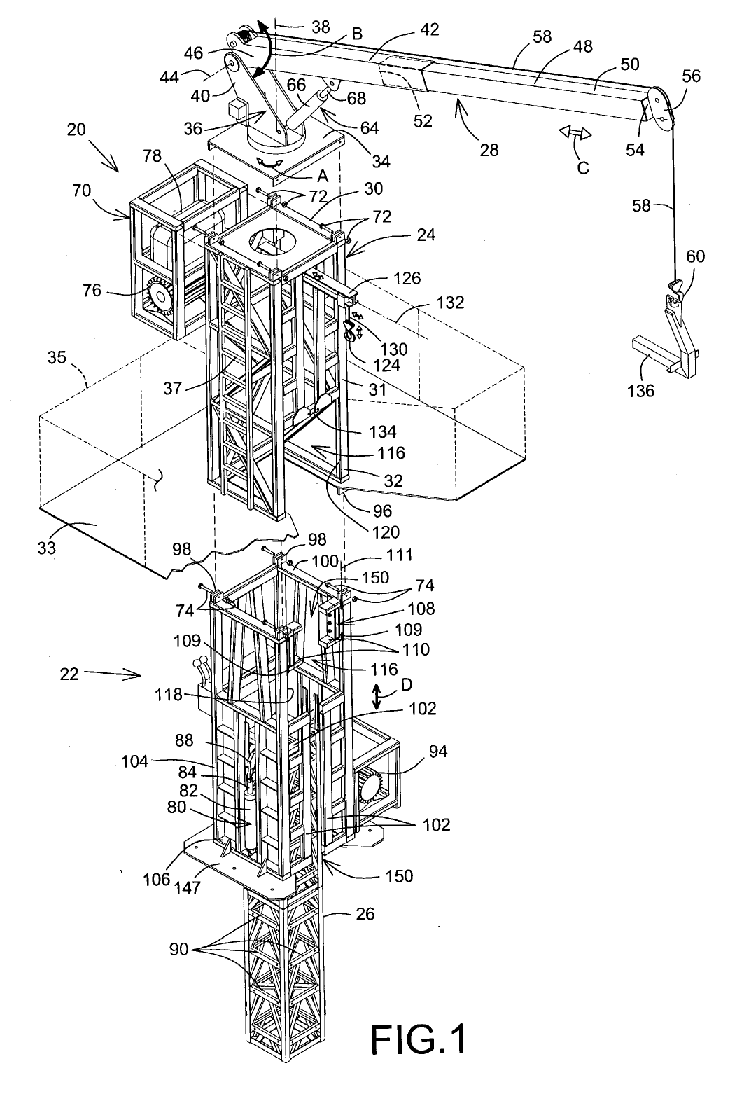

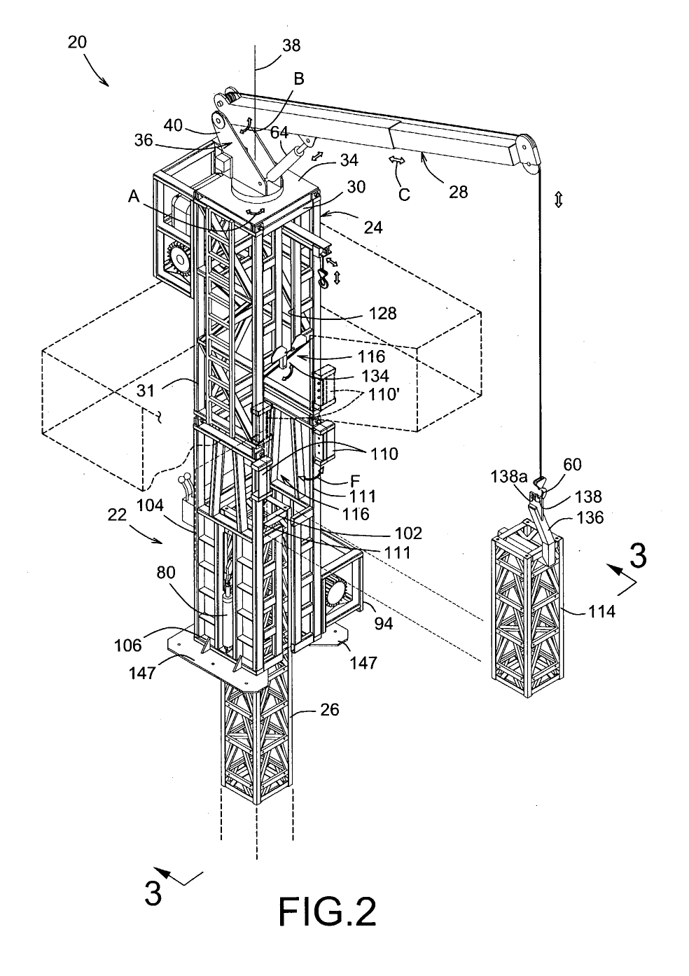

Referring to FIGS. 1 and 2, there is shown a tower crane 20 with a raising platform 22 in accordance with an embodiment of the present invention. The tower crane 20 includes the boom support structure 24 mounted on the tower 26 (or mast), and the boom assembly 28. The boom support structure 24 is generally elongated so as to surround the tower 26 and defines a first upper end 30 and a generally opposed second lower end 32. The boom support structure 24 and the tower 26 are typically of a square-shape cross-section. The boom assembly 28 is generally releasably mounted on the upper end 30 of the boom support structure 24 using bolts 72 or shear pins. A support structure platform 33, with its typically removable handrails 35, typically releasably extends outwardly from the lower end 32 of the boom support structure 24 to allow for a crane operator (not shown) to safely remain thereon and ensure a proper operation of the boom assembly 28. Similarly, a ladder 37 running along the side of the boom support structure 24 between the lower 32 and upper 30 ends thereof is provided on at least one of the sides to allow for the crane operator (not shown) to safely access the upper end 30 of the boom support structure 24 where all of the hydraulic and/or electrical couplings to the boom assembly 28 are typically located.

The boom assembly 28 is provided with a mounting plate 34 releasably mounted on the upper end 30 of the crane support structure 24. A boom 36 is rotatably mounted on the mounting plate 34 so as to pivot about a generally vertical axis, preferably collinear with a longitudinal axis 38 of the tower 26, over preferably three hundred and sixty (360) degrees (see arrow A of FIGS. 1 and 2). The boom 36 includes a boom base 40 rotatably mounted on the mounting plate 34 and a main boom segment 42 pivotally attached to the boom base 40 about a generally horizontal axis 44.

The main segment 42 defines a main segment first longitudinal end 46 pivotally attached to the boom base 40 (see arrow B of FIGS. 1 and 2), and a generally opposed main segment second longitudinal end 48. Preferably, a secondary boom segment 50 longitudinally extends from the main segment second longitudinal end 48 so as to telescopically increase the overall spanning length of the boom 36 (see arrow C of FIGS. 1 and 2).

The secondary segment 50 defines a secondary segment first longitudinal end 52 slidably moving inside the main segment 42 and a secondary segment second longitudinal end 54 supporting a hoist cable pulley mechanism 56. The hoist cable 58 of the boom assembly 28 that supports the crane hook 60 at one end thereof is windingly secured at the other end to a winch 62 mounted on the main segment first longitudinal end 46.

A double-acting hydraulic ram 64 has its cylinder part 66 pivotally secured to the boom base 40 and its piston part 68 pivotally secured to the main segment 42, at a position preferably intermediate the main segment first and second longitudinal ends 46, 48, to pivotally displace the main segment 42 about the axis 44 (see arrow B of FIGS. 1 and 2) between a first position with the main segment 42 extending in a generally horizontal configuration and a second position with the main segment 42 extending in a generally vertical upward configuration relative to the boom base 40.

The boom support structure 24 also removably carries a power system unit 70 to power all hydraulic motors for rotating the boom 36, actuating the ram 64 and rotating the winch 62. The power system unit 70 includes a hydraulic pump (not shown), and its oil reservoir (not shown), actuated by a diesel motor 76 or the like with its fuel reservoir 78. A conventional endless hydraulic rotary coupling (not shown) is preferably used to provide pressured hydraulic fluid to the hydraulic components located at and above the boom base 40 from the hydraulic pump of the power system unit 70.

The generally elongated raising platform 22, or sleeve, surrounds the tower 26 and is guided there along for up-and-down movement (see arrow D of FIGS. 1 and 2). The sleeve 22, also typically of a generally square-shape cross-section, is preferably provided with a pair of double-acting hydraulic rams 80 located on opposed sides of the sleeve 22 for its displacement along the tower 26. The cylinder part 82 of the rams 80 is generally pivotally secured to the sleeve 22 with a ram longitudinal axis being generally parallel to the tower axis 38. The free end 86 of each piston part 84 of the rams 80 is provided with a hook 88 pivotally mounted thereon. The hooks 88 successively engage, and disengage, generally horizontally oriented rungs 90 of the tower 26. The rungs 90 are substantially equally spaced apart along the tower 26. Each hook 88 pivots between a hooking position in which the hook 88 engages a rung 90 of the tower 26 and an unhooking position in which the hook 88 cannot engage the rungs 90. A hook biasing means (not shown) biases the hook 88 in its hooking position. In the upward movement of the sleeve 22, the top end surface of the hook 88 abuts the next higher rung 90 and forces the hook 88 to momentarily pivot in the unhooking position while passing at the rung level. In the downward movement of the sleeve 22, a conventional operator-activated unhooking means (not shown) for maintaining the hook 88 in the unhooking position is activated by an operator (not shown) to allow the hook 88 to clear the rungs 90 while passing at the rung level, as explained in further details in U.S. Pat. No. 5,746,290 granted to St-Germain et al. on May 5, 1998.

The piston parts 84 are retracted inside the cylinder parts 82 of the rams 80 to raise the sleeve 22 along the tower 26, while the hooks 88 are in the hooking position. Obviously, the rams could be up-side-down in which orientation the piston parts would need to be extracted out from the cylinder parts to raise the sleeve 22 along the tower 26, without departing from the scope of the present invention. Similarly, different type of raising mechanism could be used without departing from the scope of the present invention.

At least one well known conventional safety/emergency braking system (not shown) is mounted on the sleeve 22 to prevent any accidental downward movement of the latter along the tower 26; such typical safety/emergency braking system are illustrated in U.S. Pat. No. 5,159,993 granted to St-Germain on Nov. 3, 1992; U.S. Pat. No. 5,746,290 granted to St-Germain et al. on May 5, 1998 or U.S. Pat. No. 6,311,800 granted to St-Germain et al. on Nov. 6, 2001.

Preferably, the sleeve 22 carries its own power system unit 94 to activate the hydraulic rams 80. Similarly to the crane support structure 24, the power system unit 94 of the sleeve 22 is preferably removably mounted thereon.

Although not specifically shown, the sleeve 22 includes a plurality of conventional guiding bushings (see U.S. Pat. No. 5,368,125 granted to St-Germain on Nov. 29, 1994; and U.S. Pat. No. 5,746,290 granted to St-Germain et al. on May 5, 1998), preferably uniformly distributed therein, to allow the sleeve 22 to slidably engage the tower 26. The boom support structure 24 also includes a plurality of similar conventional guiding bushings to abut against the four sides of the tower 26, preferably adjacent the corners thereof.

As shown on in FIG. 1, the lower end 32 of the boom support structure 24 includes tongues 96 adapted to engage corresponding grooves 98 mounted on the upper or first longitudinal end 100 of the sleeve 22 and locked in place by bolts 74 or shear pins, such that the boom support structure 24 is supported by the sleeve 22 during assembly and disassembly of the tower 26.

As illustrated in FIG. 2, the tower crane 20 is self raising by assembling and fastening tower sections 114 on top of each other, in an end-to-end relationship relative to each other. More specifically, there is shown a tower section 114 being raised by the boom 36 for assembly on tower top end 102 of the tower 26.

In order for the tower section 114 to be assembled on tower top end 102, the sleeve 22 is raised as much as possible to the tower top end 102 and the tower crane 20, or sleeve/boom support structure assembly, needs to provide a section access opening 116 for the tower section 114 to get transversely there through. Typically, the access opening 116 extends from the sleeve 22 to the crane support structure 24.

Accordingly, the sleeve 22 includes a sleeve sidewall 104 outwardly surrounding the tower 26 between the sleeve upper end 100 and a generally opposed sleeve lower or second longitudinal end 106. The sleeve sidewall 104 includes a sleeve side opening 118 that extends therethrough inwardly from the sleeve upper end 100. The sleeve side opening 118, or sleeve portion of the access opening 116, is configured and sized for allowing at least a portion of a tower section 114 to pass generally transversely therethrough.

Typically, the sleeve 22 includes a sleeve closing body 108, or door, releasably mountable thereon to at least partially close off the sleeve side opening 118. The sleeve door 108 typically includes a pair of opposed panels 110 releasably secured to the sleeve 22 via conventional bolt fasteners 112 on respective sides of the sleeve opening 118, when in a closed opening limit position as shown in FIG. 1 so as to better secure the self-raising sleeve 22 to the tower 26.

Typically, the panels 110 of the sleeve door 108 are pivotally mounted on the sleeve sidewall 104 using conventional hinges 109 or the like. The panels 110 pivot about a respective axis 111 generally parallel to the tower axis 38 between the closed opening limit position and an opened opening limit position, as shown in FIGS. 1 and 2 respectively. When in the opened opening limit position, the panels 110 allow insertion of at least a portion of a tower section 114 through the sleeve side opening 118.

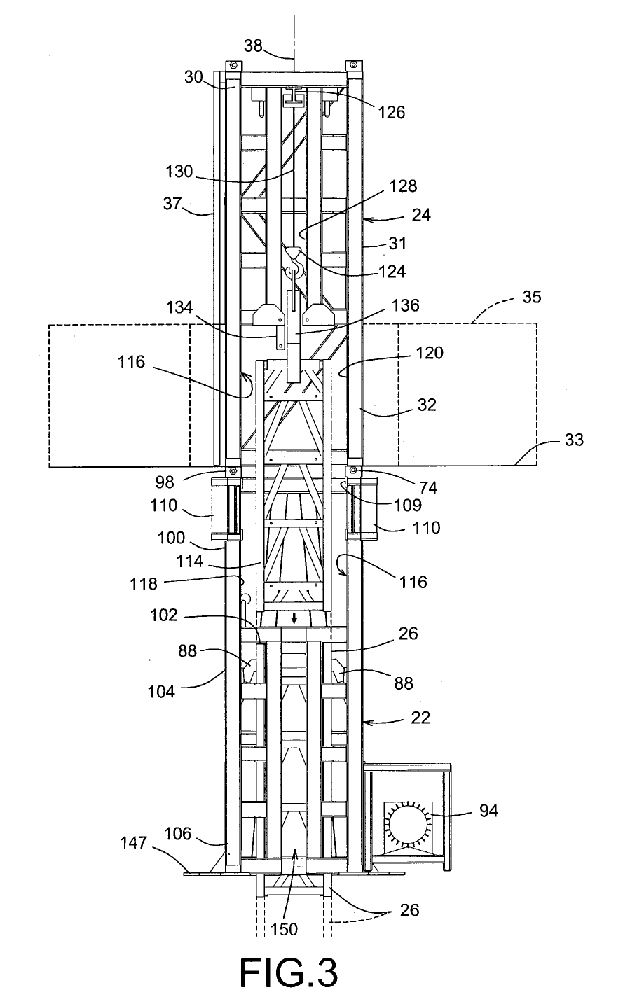

Similarly, the boom support structure 24 includes a structure sidewall 31 adjacent the lower end or portion 32 thereof. The structure sidewall 31 outwardly surrounds the tower top end 102 and includes a structure side opening 120 that extends therethrough inwardly from the structure lower end 32. The sleeve side opening 120, or structure portion of the access opening 116, is configured and sized for allowing at least a portion of a tower section 114 to pass generally transversely therethrough. Typically, as better seen in FIG. 3, the structure side opening 120 is positionable in face-to-face (in register) relationship relative to the sleeve side opening 118 so as to form a common opening or access opening 116 that allows a full length tower section 114 to pass generally transversely therethrough so as to allow the assembling of the tower section 114 onto the tower top end 102.

The structure side opening 120 could also include a pair of opposed panels 110′ releasably secured to the boom support structure 24 via conventional bolt fasteners on respective sides of the structure side opening 120, when in a closed opening limit position so as to better secure the boom support structure 24 to the tower 26. In FIG. 2, panels 110′ are shown in dotted lines in the opened opening limit position.

Obviously, depending on the length of a tower section 114, either only the sleeve side opening 118 or only the structure side opening 120 could be sized to allow a full tower section 114 to pass generally transversely therethrough.

In operation, the tower section 114 is raised from the ground by the boom 36 and brought in proximity of the sleeve/boom support structure assembly 20 where it is transferred to a local hoist 124. The local hoist 124 substantially slides along a substantially horizontal beam 126, typically fixed relative to the boom support structure 24, between a position outside the structure sidewall 31 and a position inside the structure sidewall 31 so as to ensure a proper positioning of the tower section 114 on tower top end 102 since the local hoist 124 slides until it is substantially in alignment with the axis 38 of the tower 26. To that effect, an elongated channel opening 128 extends upwardly from, in a substantially coplanar relationship relative to the support structure portion 120 of the access opening 116, thereby allowing at least a portion of the hoist cable 130 supporting the local hoist 124 to be displaced from outside of the boom support structure 24 to the inside thereof, as shown in FIGS. 2 and 3. Although not shown, the horizontal beam 126 could slides horizontally along its axis 132 between a non-operative retracted position in which it substantially lies entirely below the mounting plate 34 and an operative extended position in which it partially protrudes out, generally half of its length, from the side 122 of the boom support structure 24, transversely to the elongated channel opening 128, typically at the top thereof.

To allow opening of the elongated channel opening 128, a safety pivoting bar 134, located at the bottom end of the elongated channel opening 128, needs to be pivoted from its generally horizontal closing configuration into a substantially vertical open configuration.

In order to allow the transfer of the tower section 114 from the crane hook 60 of the boom 36 to the local hoist 124, a tower hook structure 136 releasably hooked to the tower section 114 is provided with two adjacent hoist apertures 138, 138a to enable attachment of the second hoist 124 before detaching the first crane hook 60 therefrom, and vice-versa. This transfer, as it would be obvious to one skilled in the art, could be either made manually by an operator or alternatively be made entirely automated without departing from the scope of the present invention.

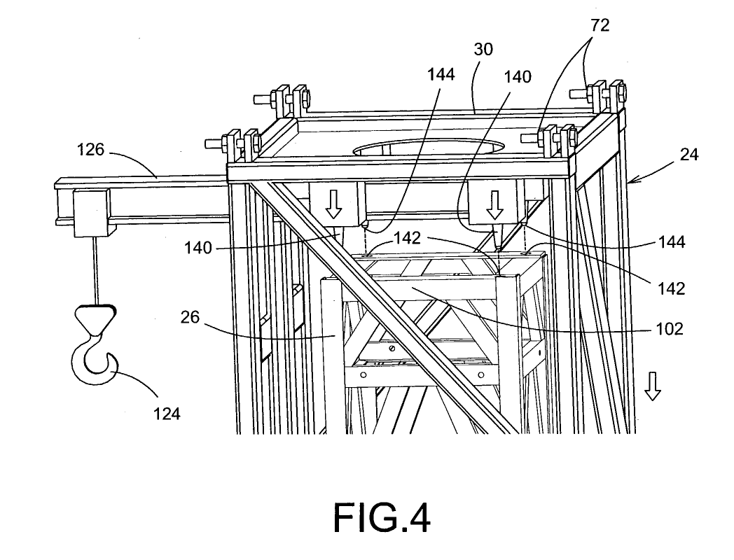

Once the last tower section 114 has been assembled on top of the tower 26, the sleeve 22 is lowered relative to the tower 26 until the top end 30 of the boom support structure 24 sits on top of the tower 26. As shown more specifically in FIG. 4, the top end 30 of the boom support structure 24 is provided with tower engaging pins 140 for engaging corresponding attachment holes 142 on the tower top end 102; these attachment holes 142 being also used to secure adjacent tower sections 114 to each other. The tower engaging pins 140 are generally vertically and downwardly oriented and have a generally tapered shape with a rounded end 144 for their self-alignment with the respective tower attachment holes 142. Typically, there are four tower engaging pins 140, one at each of the four corners of the square-shape cross-section of the tower 26.

During the self-erection of the tower crane 20, a minimum of two operators are required, a ground operator to successively attach the tower sections 114 to the crane hook 60 and to remotely operate the boom assembly 28, and a crane operator located on the support structure platform 33 to transfer the tower section 114 from the crane hook 60 to the local hoist 124 and proceed with the installation and fastening of the tower section 114 to the tower top end 102, typically using conventional bolt fasteners (not shown) extending through the corresponding attachment holes 142. During the self-disassembly of the tower crane 20, the two operators obviously perform the reverse operations.

Once the boom support structure 24 sits on the tower 26, the sleeve 22 is detached from the boom support structure 24 and is free for its up-and-down movement there along, such as any conventional self-raising platform as shown in U.S. Pat. No. 5,159,993 granted to St-Germain on Nov. 3, 1992; U.S. Pat. No. 5,746,290 granted to St-Germain et al. on May 5, 1998 or U.S. Pat. No. 6,311,800 granted to St-Germain et al. on Nov. 6, 2001.

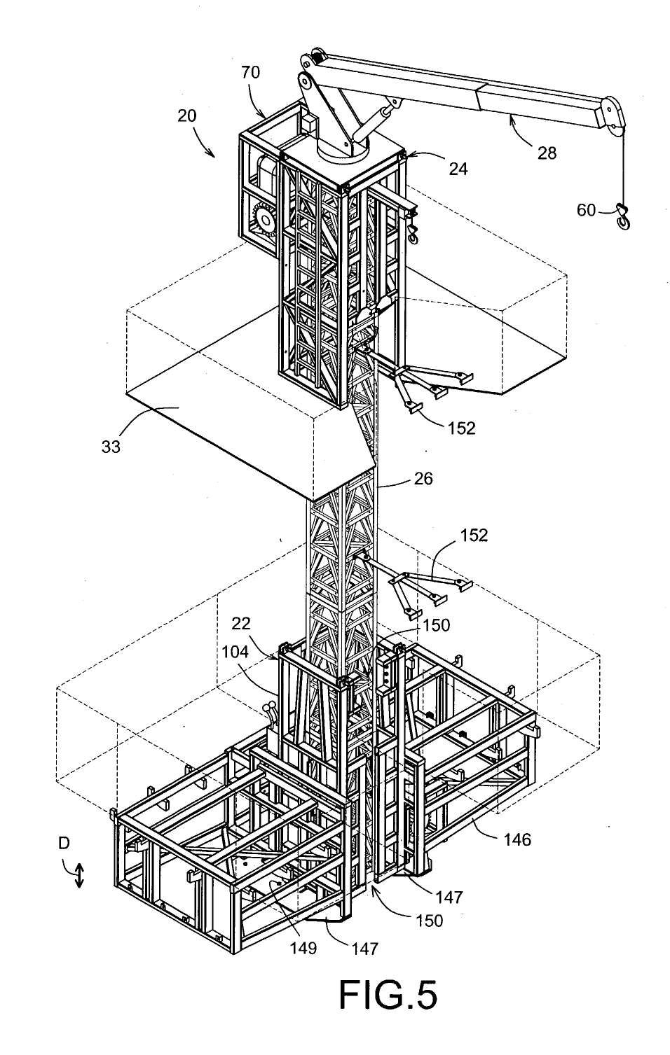

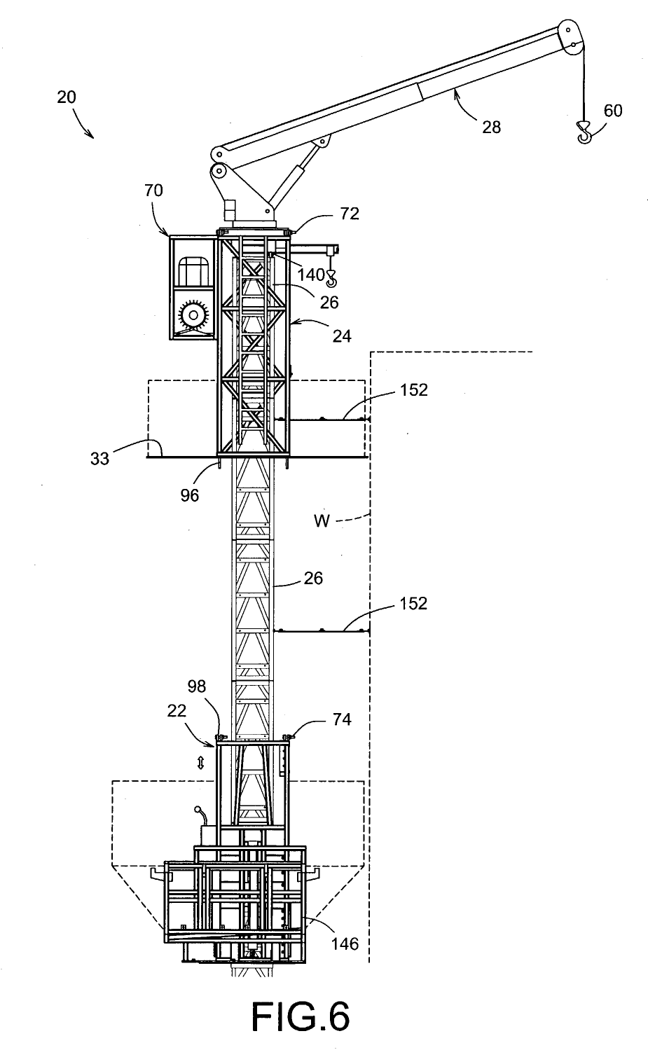

Accordingly, the sleeve 22 can be lowered down to the bottom of the tower 26 where a working platform 146 could be releasably installed via fastening bolts 149 or the like on a platform receiving plate 147 thereof, as shown in FIGS. 5 and 6. Eventually, additional platform extensions 148, shown in dotted lines in FIG. 5, and/or scaffolding bridges (not shown) could be attached to the working platforms 146 of two adjacent towers 26 to provide more working and/or storage space thereon. In this configuration, while the tower crane 20 is used for construction of a higher floor level (not shown), the sleeve 22 with the working platform 146 can be used independently to carry material to or between the lower floor levels.

Typically, the sleeve sidewall 104 partially surrounds the tower 26 and includes a slit 150 extending longitudinally there along between the sleeve upper end 100, or sleeve side opening 118, and the sleeve lower end 106. The slit 150, being a conventional slit as illustrated in U.S. Pat. Nos. 5,159,993 and 5,259,479 granted to St-Germain on Nov. 3, 1992 and Nov. 9, 1993, respectively, allows for the sleeve 22 to clear some wall anchors 152 retaining the tower 26 along the building structure 154 (see FIG. 6) during its up-and-down movement along the tower 26, as shown in FIGS. 5 and 6.

Eventually, in the case the sleeve 22 is still required at the construction site while the tower crane 20 is not needed anymore, another larger tower crane or the like crane (not shown) can easily remove the boom assembly 28 and the boom support structure 24 off the tower 26, the latter remaining in place to support the sleeve 22.

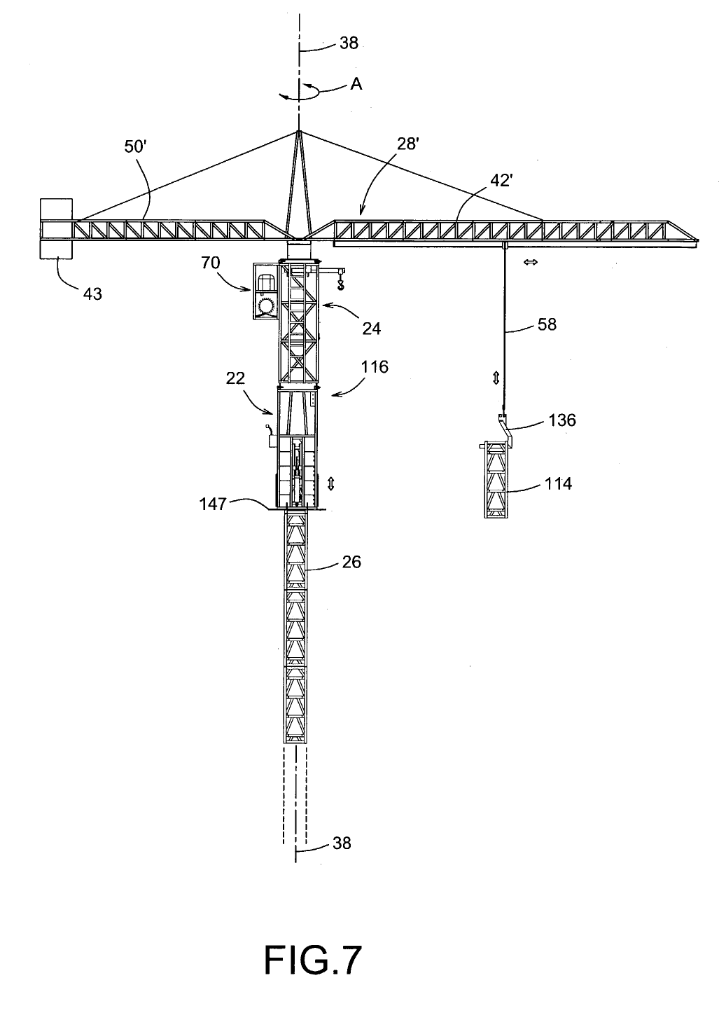

Although the boom assembly 28 shown and described in FIGS. 1 through 6 herein is a hinge-type telescopic boom 42, 50, other types of cranes such as a rotating truss-boom-type crane 28′ with a long boom 42′, 50′ and a counterweight 43, as shown in FIG. 7, can also be used without departing from the scope of the present invention.

In order to unload (and load) the sleeve 22 from a conventional trucks/trailer bed (not shown) and to assemble the sleeve 22 onto the lowest section 114 of the tower 26, the sleeve 22 is typically provided with forklift channels (not shown) at its base for allowing a conventional forklift or the like (not shown) to manipulate the sleeve 22. Similarly, the boom support structure 24 is typically provided with forklift channels (not shown) at its base below the support structure platform 33 for allowing a conventional forklift or the like (not shown) to manipulate the boom support structure 24 for installation onto the sleeve 22. Similarly, the boom assembly 28 is typically provided with forklift channels (not shown) at the mounting plate 34 for allowing a conventional forklift or the like (not shown) to manipulate the boom assembly 28 for installation onto the boom support structure 24.

Although the present tower crane with raising platform has been described with a certain degree of particularity it is to be understood that the disclosure has been made by way of example only and that the present invention is not limited to the features of the embodiments described and illustrated herein, but includes all variations and modifications within the scope and spirit of the invention as hereinafter claimed.

I claim:

1. A self-erecting tower crane for use on a construction site, said tower crane being supported at a top end of a tower, the tower including tower sections assembled in an end-to-end relationship relative to one another along a tower axis, said tower crane comprising:
a boom assembly for selectively raising tower sections above ground;
a boom support structure defining generally opposed structure upper and lower portions, said structure upper portion rotatably supporting said boom assembly relative to the tower axis, said structure lower portion being configured and sized for mounting on and releasably securing to the tower top end;
a self-raising sleeve mounted on the tower for axial movement therealong, said self-raising sleeve selectively and releasably supporting said boom support structure on the tower, said self-raising sleeve and said boom support structure being configured and sized for allowing a tower section to be assembled to the tower top end so as to allow self-erection of said tower crane.

2. The tower crane of claim 1, wherein said self-raising sleeve includes a sleeve sidewall for outwardly surrounding the tower, said sleeve sidewall defining generally opposed sleeve first and second longitudinal ends, said sleeve sidewall including a sleeve side opening extending therethrough inwardly from said sleeve first end, said sleeve side opening being configured and sized for allowing at least a portion of a tower section to pass generally transversely therethrough so as to assemble the tower section onto the tower top end and extend the tower.

3. The tower crane of claim 2, wherein said sleeve side opening is configured and sized for allowing a full tower section to pass generally transversely therethrough.

4. The tower crane of claim 2, wherein said self-raising sleeve includes a sleeve closing body releasably mountable thereon to at least partially close said sleeve side opening.

5. The tower crane of claim 4, wherein said sleeve closing body is pivotally mounted on said sleeve sidewall, said sleeve closing body pivoting between first and second limit positions, said sleeve closing body allowing insertion of at least a portion of a tower section through said sleeve opening when in said first position and at least partially closing said sleeve opening so as to better secure said self-raising sleeve to the tower when in said second limit position.

6. The tower crane of claim 1, wherein said structure lower portion includes a structure sidewall for outwardly surrounding the tower, said structure sidewall defining a structure first longitudinal end thereof located away from said structure upper portion, said structure sidewall including a structure side opening extending therethrough inwardly from said structure first end, said structure side opening being configured and sized for allowing at least an upper portion of a tower section to pass generally transversely therethrough so as to assemble the tower section onto the tower top end.

7. The tower crane of claim 6, wherein said structure side opening is configured and sized for allowing a full tower section to pass generally transversely therethrough.

8. The tower crane of claim 6, wherein said structure lower portion includes a structure closing body releasably mountable thereon to at least partially close said structure side opening.

9. The tower crane of claim 8, wherein said structure closing body is pivotally mounted on said structure sidewall, said structure closing body pivoting between first and second limit positions, said structure closing body allowing insertion of at least an upper portion of a tower section through said structure opening when in said first position and at least partially closing said structure opening so as to better secure said boom support structure to the tower when in said second limit position.

10. The tower crane of claim 2, wherein said structure lower portion includes a structure sidewall for outwardly surrounding the tower, said structure sidewall including a structure side opening extending therethrough, said structure sidewall defining a structure first longitudinal end thereof located away from said structure upper portion, said structure side opening being configured, sized and positionable in face-to-face relationship relative to said sleeve side opening so as to form a common opening that allows a full tower section to pass generally transversely therethrough so as to assemble the tower section onto the tower top end.

11. The tower crane of claim 1, wherein said structure upper portion includes a boom interface releasably mounted thereon, said boom interface rotatably supporting said boom assembly relative to the tower axis.

12. The tower crane of claim 1, wherein said boom support structure includes a crane power system operatively connected to said crane for operation thereof.

13. The tower crane of claim 12, wherein said boom support structure includes a user platform secured thereto for allowing a user to selectively and closely operate said tower crane.

14. The tower crane of claim 12, wherein said crane power system includes a remote controller connected thereto so as to allow a user to remotely operate said tower crane.

15. The tower crane of claim 1, wherein said self-raising sleeve includes a sleeve power system operatively connected thereto for axial displacement of said self-raising sleeve relative to the tower.

16. The tower crane of claim 15, wherein said self-raising sleeve includes a platform releasably mounted thereon so as to selectively support material to be carried along the tower.

17. The tower crane of claim 15, wherein the tower includes a tower anchor to secure the tower to an adjacent building structure, said self-raising sleeve including a sleeve sidewall outwardly surrounding the tower, said sleeve sidewall having a longitudinal slit extending therethrough for allowing said self-raising sleeve to clear the tower anchor when being displaced along the tower.

18. The tower crane of claim 15, wherein the tower includes spaced-apart generally horizontal rungs, said sleeve power system including a hydraulic ram mounted on said self-raising sleeve, said hydraulic ram including a hook member for releasable engagement with the tower rungs.

19. The tower crane of claim 1, wherein said structure lower portion includes a structure sidewall for outwardly surrounding the tower, said structure lower portion includes a hoist beam extending generally outwardly therefrom and through said structure sidewall, said hoist beam including a cable hoist assembly for releasably supporting a tower section, said cable hoist assembly being displaceable along said hoist beam between a first position outside said structure sidewall and a second position inside said structure sidewall.

20. The tower crane of claim 19, wherein said structure sidewall defines a structure first longitudinal end thereof located away from said structure upper portion, said structure sidewall including a structure channel opening extending therethrough inwardly from said structure first end, said hoist beam extending through said structure channel opening for allowing at least a portion of said cable hoist assembly to be displaced between said first and second positions outside and inside.
